(19) United States
(12) Patent Application Publication
(10) Pub. No.: US 2024/0279419 A1
(43) Pub. Date: Aug. 22, 2024

(54) RIGID PUR/PIR FOAMS, METHOD OF SYNTHESIS OF A POLYOL FOR PRODUCING RIGID PUR/PIR FOAMS, AND METHOD FOR PRODUCING RIGID PUR/PIR FOAMS

(71) Applicant: puren GmbH, Überlingen (DE)

(72) Inventors: Thomas BOMMER, Überlingen (DE); Anton DEMHARTER, Hohenfels-Liggersdorf (DE); Benjamin FELKER, Dudenhofen (DE); Michael RHEIN, Birkenau (DE); Michael MEIER, Jockgrim (DE)

(21) Appl. No.: 18/565,459

(22) PCT Filed: May 25, 2022
(86) PCT No.: PCT/EP2022/064298

§ 371 Date: Nov. 29, 2023

(30) Foreign Application Priority Data
May 31, 2021 (DE) 10 2021 114 040.4

(51) Int. Cl. C08J 9/14; C08G 18/32; C08G 63/672; C08G 63/85

(52) U.S. Cl. CPC C08J 9/141; C08G 18/3218; C08G 63/672; C08G 63/85; C08G 2110/0025; C08G 2330/00; C08J 2203/14; C08J 2375/04

(57) ABSTRACT

A rigid PUR/PIR foam is produced from at least one polyol which is synthesized from at least one polyhydric alcohol and at least one aromatic dicarboxylic acid, wherein the polyol is at least partially produced from renewable raw materials.

### CROSS-REFERENCE TO RELATED APPLICATIONS

This patent application is a U.S. national stage application of international patent application PCT/EP2022/064298, filed on May 25, 2022, which is based on and claims priority to German patent application DE 10 2021 114 040.4, filed on May 31, 2021, the contents of which are incorporated herein by reference.

### PRIOR ART

The invention relates to a rigid PUR/PIR foam, to a method for synthesizing a polyol for producing rigid PUR/PIR foams and to a method for producing rigid PUR/PIR foams.

Rigid polyurethane (PUR) foams and rigid polyisocyanurate (PIR) foams are known from the prior art and due to their very low thermal conductivity are used for thermal insulation in a very wide variety of applications, especially as insulation materials in cold chains or in the construction industry and in industrial applications. The production of rigid PUR/PIR foams requires two main components, namely an isocyanate component and a polyol component, wherein the desired properties of the rigid PUR/PIR foams are adjustable inter alia through suitable choice of the polyol component and the corresponding mixing ratios of the main components. Thus the production of particularly stable rigid PUR/PIR foams which may be employed for example as building materials in the form of insulation sheets preferably employs aromatic polyester polyols as the polyol component, these being notable for their advantageous properties in the rigid PUR/PIR foams produced therefrom in respect of their fire characteristics and thermal conductivity. Employed starting materials for polyester polyols for producing prior art rigid PUR/PIR foams are petroleum-based aromatic dicarboxylic acids, for example phthalic acid or terephthalic acid, which are used in a synthesis with a polyhydric alcohol to afford a polyester polyol. As a result of increased environmental awareness and limited resources for petroleum-based raw materials there is increasingly a forward-looking need, also for the production of rigid PUR/PIR foams, to substitute the petroleum-based aromatic carboxylic acids with suitable more sustainable alternatives. While aliphatic chemical compounds are relatively easy to produce sustainably from renewable raw materials, for example from vegetable oils, aromatic chemical compounds have hitherto hardly been obtainable from sustainable sources. Thus the prior art has hitherto also failed to disclose bio-based alternatives to petroleum-based aromatic dicarboxylic acids which would simultaneously also allow production of rigid PUR/PIR foams with comparable technical characteristics relative to conventional rigid PUR/PIR foams. Bio-based production of rigid PUR/PIR foams using methods known from the prior art has thus not hitherto been possible.

It is especially an object of the present invention to provide a congeneric rigid PUR/PIR foam having improved properties in terms of sustainability. The object is achieved in accordance with the invention.

### ADVANTAGES OF THE INVENTION

The invention is based on a rigid PUR/PIR foam produced from at least one polyol which is synthesized from at least one polyhydric alcohol and at least one aromatic dicarboxylic acid.

It is proposed that the polyol is at least partially produced from renewable raw materials.

Such an embodiment advantageously makes it possible to produce a rigid PUR/PIR foam having improved properties in terms of sustainability. In particular, the use of petroleum-based starting materials can advantageously be reduced, preferably minimized or even completely replaced, thus making it possible to save finite resources and reduce emissions of climate-damaging greenhouse gases in the production of rigid PUR/PIR foams. The rigid PUR/PIR foam according to the invention features not only significantly improved properties in terms of sustainability but especially also advantageous technical characteristics especially in terms of low thermal conductivity and low fire characteristics which are comparable to, or even exceed, conventional rigid PUR/PIR foams.

The rigid PUR/PIR foam being “produced” from at least one polyol is to be understood as meaning that the rigid PUR/PIR foam comprises the at least one polyol as at least one main component, wherein the polyol especially comprises at least 25% by weight, preferably at least 30% by weight, of the total mass of the rigid PUR/PIR foam. The rigid PUR/PIR foam is produced by a polyaddition reaction from the at least one polyol, at least one isocyanate component, at least one blowing agent and in particular from further additives, in particular flame retardants and/or activators and/or emulsifiers and/or foam stabilizers, and/or further additives that appear useful to those skilled in the art, optionally using at least one catalyst. The polyol could be a polyether polyol. The polyol is preferably a polyester polyol.

The polyhydric alcohol for synthesis of the polyol is preferably a dihydric alcohol, in particular ethylene glycol (MEG), preferably diethylene glycol (DEG). However, the use of trihydric, tetrahydric or higher-hydric alcohols would also be conceivable in principle. The polyhydric alcohol could be a product of synthetic production. It is preferable when the polyhydric alcohol is at least predominantly produced from renewable raw materials.

The aromatic dicarboxylic acid could be an aromatic dicarboxylic acid that has been synthetically produced from petroleum-based raw materials, for example phthalic acid or terephthalic acid. However, it is preferable when the aromatic dicarboxylic acid is at least predominantly produced from renewable raw materials.

The term “renewable raw materials” is to be understood as meaning organic raw materials, in particular vegetable raw materials, which are derived from agricultural and/or forestry production and are cultivated by humans specifically for secondary applications outside the food and feed industry or which are by-products and/or waste products from agriculture and/or the food and feed industry. Renewable raw materials in the context of the present invention are exclusively organic raw materials not of fossil origin. The renewable raw materials in the present context are preferably domestic products from agricultural and/or forestry production and also their by-products and/or waste products, provided these are not subject to waste law, and also algae.

The indication that the polyol is “at least partially” produced from renewable raw materials is to be understood as meaning that at least 50% by weight, in particular at least 60% by weight, advantageously at least 70% by weight, particularly advantageously at least 80% by weight, preferably at least 90% by weight and particularly preferably at least 95% by weight, of the polyol is produced from renewable raw materials.

It is further proposed that at least the aromatic dicarboxylic acid is predominantly produced from renewable raw materials. This can advantageously further improve the sustainability of the rigid PUR/PIR foam. The aromatic dicarboxylic acid is produced from renewable raw materials to a predominant proportion of more than 50% by weight, in particular of more than 60% by weight, advantageously of more than 70% by weight, particularly advantageously of more than 80% by weight, preferably of more than 90% by weight and particularly preferably to a proportion of 95% by weight to 100% by weight inclusive.

It is additionally proposed that the aromatic dicarboxylic acid is 2,5-furandicarboxylic acid (FDCA) which is predominantly produced from renewable raw materials. This advantageously makes it possible to produce a sustainably produced rigid PUR/PIR foam with comparable or improved technical characteristics compared to conventional petroleum-based rigid PUR/PIR foams. The 2,5-furandicarboxylic acid may be at least predominantly produced from renewable raw materials for example by dehydration of hexoses, in particular fructose, which is obtainable for example from sugar beet or sugar cane, and subsequent oxidation of the resulting hydroxymethylfurfural (5-HMF). It is also conceivable to produce 2,5-furandicarboxylic acid from wastes from agriculture and/or the food industry, for example from end-of-life baked goods from which hydroxymethylfurfural (5-HMF) may be obtained as a starting material for 2,5-furandicarboxylic acid by hydrothermal treatment and subsequent extraction from an aqueous solution. It is also conceivable to produce 2,5-furandicarboxylic acid from inulin-accumulating plants, for example from inulin-containing chicory roots which are generated as agricultural waste, wherein inulin is initially extracted, converted into hydroxymethylfurfural (5-HMF) by hydrothermal dehydration and subsequently oxidized by biocatalysis or heterogeneous catalysis to afford 2,5-furandicarboxylic acid (FDCA).

In a further advantageous embodiment it is proposed that at least the polyhydric alcohol is predominantly produced from renewable raw materials. This can advantageously further improve the sustainability of the rigid PUR/PIR foam. The polyhydric alcohol is produced from renewable raw materials to a predominant proportion of more than 50% by weight, in particular of more than 60% by weight, advantageously of more than 70% by weight, particularly advantageously of more than 80% by weight, preferably of more than 90% by weight and particularly preferably to a proportion of 95% by weight to 100% by weight inclusive. It is preferable when both the polyhydric alcohol and the aromatic dicarboxylic acid are predominantly produced from renewable raw materials. This advantageously makes it possible to provide a rigid PUR/PIR foam comprising a polyol predominantly produced from renewable raw materials and thus having particularly advantageous characteristics in terms of sustainability.

It is further proposed that the polyol has an OH number greater than 250 mg KOH/g. This advantageously makes it possible to provide a rigid PUR/PIR foam having a high crosslinking density and thus good dimensional stability and high compressive strength as desired for many applications. The polyol advantageously has an OH number of more than 250 mg KOH/g and less than 400 mg KOH/g, by preference less than 350 mg KOH/g, preferably less than 300 mg KOH/g and particularly preferably less than 275 mg KOH/g.

It is moreover proposed that the polyol has a content of free glycol of greater than 6% by weight with respect to the total mass of the polyol. This advantageously makes it possible to provide a rigid PUR-PIR foam having a broad application spectrum. The polyol preferably has a content of free glycol of less than 20% by weight, particularly preferably of not more than 15% by weight, with respect to the total mass of the polyol.

It is further proposed that the polyol has an average molar mass of less than 1000 g/mol. The polyol advantageously has an average molar mass/a molecular weight between 400 g/mol and 900 g/mol, preferably between 600 g/mol and 850 g/mol. It is particularly preferable when the polyol has an average molar mass of less than 700 g/mol. This advantageously makes it possible to provide a rigid PUR/PIR foam having a low density (D). The average molar mass of the polyol is determinable for example by nuclear magnetic resonance spectroscopy (1H-NMR). It is additionally possible to perform correlated spectroscopy (COSY) and/or heteronuclear single quantum coherence (HSQC) and/or heteronuclear multiple bond correlation (HMBC) and/or size exclusion chromatography (SEC) and/or infrared spectroscopy (IR) to determine the structure and/or further features of the polyol.

In a further advantageous embodiment it is proposed that the polyol is synthesized at least partially from at least one further dicarboxylic acid. This advantageously makes it possible to reduce a dynamic viscosity of the polyol and thus achieve an improved processability. It is therefore advantageously possible to provide a rigid PUR/PIR foam having improved characteristics in terms of manufacturability. The further dicarboxylic acid could be an aromatic dicarboxylic acid, for example phthalic acid or terephthalic acid.

However, in a particularly advantageous embodiment it is proposed that the further dicarboxylic acid is an aliphatic dicarboxylic acid which is predominantly produced from renewable raw materials. Such an embodiment can advantageously further improve the sustainability of the rigid PUR/PIR foam to advantageously reduce a dynamic viscosity of the polyol at the same time and thus improve production of the rigid PUR/PIR foam. The further dicarboxylic acid is preferably an aliphatic C4 to C10 dicarboxylic acid which is predominantly produced from renewable raw materials. Without being limited thereto the further dicarboxylic acid could for example be succinic acid and/or adipic acid which are predominantly produced from renewable raw materials. The further dicarboxylic acid is produced from renewable raw materials to a predominant proportion of more than 50% by weight, in particular of more than 60% by weight, advantageously of more than 70% by weight, particularly advantageously of more than 80% by weight, preferably of more than 90% by weight and particularly preferably to a proportion of 95% by weight to 100% by weight inclusive.

It is additionally proposed that the polyol has a dynamic viscosity between 3000 mPas and 12 000 mPas. This advantageously makes it possible to provide an improved processability of the polyol and thus a rigid PUR/PIR foam having improved characteristics in terms of producibility. The polyol especially has a dynamic viscosity between 4000 mPas and 8000 mPas, advantageously between 4000 mPas and 7000 mPas, particularly advantageously between 4000 mPas and 6000 mPas, preferably between 4000 mPas and 5500 mPas and particularly preferably between 4000 mPas and 5000 mPas. The specified dynamic viscosities relate to measurements according to the standard DIN EN ISO 3219.

It is further proposed that the rigid PUR/PIR foam has a thermal conductivity between 0.018 W/(mK) and 0.021 W/(mK). This advantageously makes it possible to provide a rigid PUR/PIR foam having improved characteristics in terms of thermal insulation. The rigid PUR/PIR foam preferably has a thermal conductivity between 0.019 W/(mK) and 0.020 W/(mK). The thermal conductivity of the rigid PUR/PIR foam in the range between 0.018 W/(mK) and 0.021 W/(mK) is a measured value measured immediately after production. Conventional rigid PUR/PIR foams having particularly good thermal insulation and produced on the basis of petroleum-based polyols, a polyisocyanate and the blowing agent pentane typically have thermal conductivities measured immediately after production in the range between 0.020 W/(mK) and 0.021 W/(mK). It is known that the plastic polyethylene furanoate (PEF) in the use of bio-based plastic containers has an improved diffusion resistance compared to the plastic polyethylene terephthalate (PET), wherein a PEF O₂ barrier has up to six times the diffusion resistance of PET, a PEF CO₂ barrier has up to three times the diffusion resistance of PET and a PEF H₂O barrier has up to twice the diffusion resistance of PET. Since PEF is composed of the starting materials 2,5-furandicarboxylic acid (FDCA) and ethylene glycol (MEG) and the polyol for producing the rigid PUR/PIR foam according to the invention is in particularly preferred embodiments produced from a polyol composed of furandicarboxylic acid (FDCA) and diethylene glycol (DEG), the proportion of which in the rigid PUR/PIR foam accounts for at least 25% by weight, preferably at least 30%, of the total mass, it may be assumed that the very good barrier properties of the PEF relative to O₂, CO₂ and H₂O are also proportionally transferable to the rigid PUR/PIR foam according to the invention in accordance with the proportion of the polyol. It is therefore assumed that this reduces the thermal conductivity of the rigid PUR/PIR foam according to the invention relative to conventional, pentane-blown rigid PUR/PIR foams by at least 5% to achieve thermal conductivities between 0.018 W/(mK) and 0.021 W/(mK), preferably between 0.019 W/(mK) and 0.020 W/(mK). The specified thermal conductivity of the rigid PUR/PIR foam refers to measurements according to DIN EN 12667.

The present invention further proceeds from a method for synthesizing a polyol for production of rigid PUR/PIR foams, in particular according to any of the above-described configurations, from at least one polyhydric alcohol and at least one aromatic dicarboxylic acid. It is proposed that the starting materials employed are at least partially renewable raw materials. Such a method can advantageously provide a sustainable polyol for the production of rigid PUR/PIR foams. The indication that renewable raw materials are “at least partially” employed as the starting materials is to be understood as meaning that at least 25% by weight, preferably at least 30% by weight, of the total mass of starting materials employed in the method are produced from renewable raw materials. The method comprises at least one method step. It is preferable when the method comprises at least two method steps. The method is preferably a single-stage synthesis. It is preferable when the polyhydric alcohol is initially charged and preheated in one method step and the aromatic dicarboxylic acid and preferably at least one catalyst is added to the polyhydric alcohol in a further method step and the reaction mixture is subsequently stirred. It is preferable when condensate generated in the further method step is continuously distilled off, in particular to shift a reaction equilibrium to the product side and to prevent a reverse reaction in the form of an ester cleavage of the polyol. In order to achieve complete conversion of the reactants the reactant mixture is advantageously stirred for at least 5 seconds, preferably for at least 7.5 seconds, particularly preferably for at least 10 seconds. Shorter stirring times would also be conceivable in principle but would be expected to result in a lower conversion of the starting materials to polyol. It is preferable when the reaction mixture is stirred at speeds of 150 RPM to 450 RPM with at least one stirring means. However, depending on the type and size of the employed reactor and the employed stirring means other speeds could also prove advantageous.

It is further proposed to employ at least one aromatic dicarboxylic acid which is predominantly produced from renewable raw materials. This advantageously makes it possible to achieve a particularly sustainable process.

In a particularly advantageous embodiment it is proposed that 2,5-furandicarboxylic acid (FDCA) which is predominantly produced from renewable raw materials is employed as the aromatic dicarboxylic acid. This advantageously make it possible to achieve a particularly sustainable method while simultaneously allowing synthesis of a polyol having particularly advantageous properties for the production of rigid PUR/PIR foams. It is particularly preferable to employ 2,5-furandicarboxylic acid (FDCA) which is predominantly produced from renewable raw materials as the aromatic dicarboxylic acid and diethylene glycol (DEG) which is advantageously predominantly produced from renewable raw materials to obtain aromatic poly(diethylene glycol furanoate) (PDEF) as the polyol.

In a particularly preferred embodiment it is proposed to employ diethylene glycol (DEG) as the polyhydric alcohol and to perform the method according to the following generalized reaction scheme:

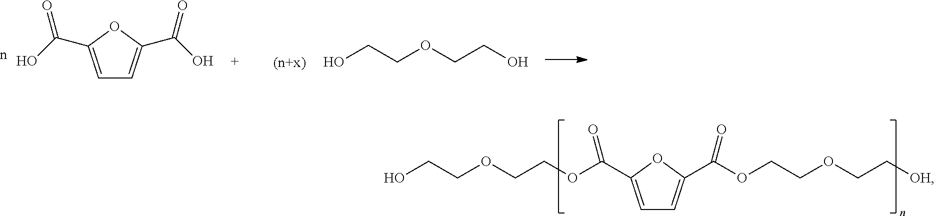

wherein n may especially assume positive values between 1.0 and 10.0 and x may especially assume positive values between 0.0 and 5.0. This advantageously allows the method for synthesis of the polyol to be particularly well adapted to the production of rigid PUR/PIR foams. In the abovementioned generalized reaction scheme, n may especially assume positive values between 1.0 and 10.0, advantageously between 1.0 and 7.0, particularly advantageously between 1.0 and 5.0, by preference between 1.0 and 4.0, preferably between 2.0 and 4.0. It is particularly preferable when n has a value between 2.0 and 3.0. Positive values greater than 10.0 are in principle also conceivable for n. In the present case the specified value ranges of n relate to macromolecules of the polyol and therefore represent statistical averages. In the abovementioned reaction scheme, x may especially assume positive values between 0 and 5, advantageously between 0 and 4, particularly advantageously between 0 and 3, by preference between 0 and 2 and preferably between 0.5 and 1.5. It is particularly preferable when x has a value of 1. Positive values greater than 5.0 are in principle also conceivable for x.

It is further proposed to employ at least one polyhydric alcohol which is predominantly produced from renewable raw materials. This can advantageously yet further improve the sustainability of the process.

It would be conceivable to perform the method without a catalyst. However, to achieve advantageous reaction kinetics it is proposed to employ at least one catalyst. Metal oxides and/or organometallic compounds could be employed as catalysts. The use of dibutyltin(IV) oxide as catalyst would be conceivable for example. With respect to the starting concentration of dicarboxylic acid(s) the catalyst is added in an equivalent concentration of at least 0.01, in particular of at least 0.02, advantageously of at least 0.03, preferably of at least 0.04 and particularly preferably of at least 0.05, with respect to the starting concentration of dicarboxylic acid.

In a particularly advantageous embodiment it is proposed that at least one titanium-containing catalyst is employed. Titanium-containing catalysts are non-toxic and thus advantageously allow simple and safe performance of the process. Furthermore, titanium-containing catalysts especially feature a high catalytic activity which advantageously allows particularly efficient process management to be achieved. It is possible to employ two or more different titanium-containing catalysts or at least one titanium-containing catalyst and at least one titanium-free catalyst. It is preferable to employ precisely one titanium-containing catalyst. As is well known a synthesis of polyols from polyhydric alcohols and dicarboxylic acids preferably comprises at least two reaction steps, wherein a first reaction step comprises conversion into a corresponding dicarboxylic diester and a second reaction step comprises a polycondensation to afford a polyol, wherein polyhydric alcohol and water are released as condensate. Both reaction steps require catalysts or are at least accelerated thereby, wherein titanium-containing catalysts are advantageously employable for the catalysis of both reaction steps. It is thus possible to provide a particularly efficient method for synthesis of a polyol for production of rigid PUR/PIR foams when precisely one titanium-containing catalyst is used. The titanium-containing catalyst could be sodium titanate for example. The titanium-containing catalyst is preferably tetraisopropyl orthotitanate and particularly preferably titanium tetrabutoxide.

The polyhydric alcohol could be employed for example in an equivalent concentration of 2.5 or 3.0 with respect to a starting concentration of the dicarboxylic acid(s). However, in a particularly advantageous embodiment it is proposed that the polyhydric alcohol is employed in an equivalent concentration between 1.75 and 2.00 with respect to a starting concentration of the aromatic dicarboxylic acid(s). Such an embodiment advantageously makes it possible to achieve complete conversion of the starting materials to polyol coupled with a very low degree of polymerization and accordingly a very low dynamic viscosity of the polyol. It is thus possible to provide a particularly efficient method for synthesis of a polyol for production of rigid PUR/PIR foams. In particular it is advantageously possible to achieve a high product yield at the lowest possible use of polyhydric alcohol, thus advantageously ensuring a high cost efficiency of the method and further improving sustainability. In addition it is advantageously possible to achieve a very low content of free glycol since an excessive proportion of free glycol, in particular a proportion of more than 20% by weight with respect to the total mass of the polyol, can adversely affect the technical characteristics of a rigid PUR/PIR foam produced from the polyol.

It is also proposed to stir a reaction mixture composed of the starting materials at a temperature between 60° C. and 240° C. Especially to achieve a reaction rate sufficient for economic purposes the reaction mixture is advantageously stirred at a temperature of at least 75° C., particularly advantageously of at least 100° C., preferably of at least 125° C. and particularly preferably of at least 150° C. However, the selected temperature also has a great effect on the polymerization rate, wherein a degree of polymerization of the polyol and accordingly also a dynamic viscosity of the polyol increase with increasing temperature. Excessive temperatures may moreover lead to undesired side reactions and/or to partial evaporation of the starting materials. The reaction mixture is therefore especially stirred at a temperature of not more than 230° C., advantageously of not more than 220° C., particularly advantageously of not more than 210° C., preferably of not more than 200° C. and particularly preferably of not more than 190° C. Depending on the batch sizes of the reaction mixture it may be necessary, especially for smaller batch sizes on a laboratory scale, for the reaction mixture to be heated using at least one external heat source to achieve a temperature between 60° C. and 240° C. Since the reaction is exothermic it may by contrast also be necessary, especially for large batch sizes on an industrial scale, for the reaction mixture to be cooled in order not to exceed a temperature of 240° C. In the applicant's own tests a reaction temperature of 160° C., at which the reaction mixture was stirred, has proven particularly advantageous to achieve a sufficiently rapid reaction and also to achieve a very low degree of polymerization and thus a very low dynamic viscosity of the polyol. Since the temperature of the reaction mixture depends not only on the selected reactants, the selected catalyst and the batch size but also on a multiplicity of further parameters, such as for example the stirring speed, the type of stirrer employed, the thermal conductivities and heat transfer coefficients of the components of the employed reactor and the like it could in principle also be the case that, for some reactors for performing the process, temperatures deviating from the abovementioned ranges prove advantageous. In particular, temperatures of the reaction mixture of greater than 240° C. may in principle also be conceivable depending on the type of the employed catalyst.

It is further proposed that at least one further dicarboxylic acid is used in addition. This advantageously makes it possible to reduce the dynamic viscosity of the synthesized polyol. The further dicarboxylic acid may be an aromatic dicarboxylic acid, for example phthalic acid or terephthalic acid. The further dicarboxylic acid is preferably an aliphatic dicarboxylic acid, particularly preferably an aliphatic dicarboxylic acid at least predominantly produced from renewable raw materials, for example succinic acid and/or adipic acid. This advantageously makes it possible to reduce the dynamic viscosity of the synthesized polyol using renewable raw materials. This accordingly makes it possible to achieve a particularly sustainable process.

In a further advantageous embodiment it is proposed that at least one surfactant predominantly produced from renewable raw materials is additionally employed. This advantageously makes it possible using renewable raw materials to synthesize a polyol having a higher degree of polymerization without this simultaneously increasing the dynamic viscosity of the polyol. The surfactant is produced from renewable raw materials to a predominant proportion of more than 50% by weight, in particular of more than 60% by weight, advantageously of more than 70% by weight, particularly advantageously of more than 80% by weight, preferably of more than 90% by weight and particularly preferably to a proportion of 95% by weight to 100% by weight inclusive. The surfactant could for example be a polyethylene glycol dodecyl ether predominantly produced from renewable raw materials and obtainable under the trade name Brij™ L4.

The invention further relates to a polyol synthesized by a method according to any of the above-described embodiments. A polyol synthesized by means of the method according to the invention is notable on the one hand especially for its advantageous properties in terms of sustainability and on the other hand especially for its characteristics for production of rigid PUR/PIR foams which are comparable to or even improved over conventional polyols synthesized from petroleum-based starting materials. In particular the polyol synthesized by means of the method according to the invention exhibits comparable or improved properties in terms of its foamability into rigid PUR/PIR foams. Processing of the polyol according to the invention into rigid PUR/PIR foams therefore requires no appreciable changes and/or changes going beyond what is customary to the formulation and the process engineering of the foaming plants so that conformant rigid PUR/PIR foams may advantageously be provided with usual or improved quality while simultaneously markedly improving sustainability relative to conventional rigid PUR/PIR foams. Due to the synthesis of the polyol from aromatic dicarboxylic acids which are predominantly produced from renewable raw materials the polyol according to the invention would be easily distinguishable by a person skilled in the art from conventional polyols for production of rigid PUR/PIR foams hitherto known from the prior art using suitable analytical methods, for example nuclear magnetic resonance spectroscopy (1H-NMR).

It is additionally proposed that the polyol is poly(diethylene glycol furanoate) (PDEF) which has the following generalized structure:

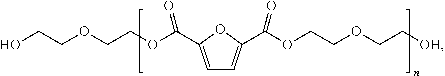

wherein n may especially assume positive values between 1.0 and 10.0. This advantageously makes it possible to provide a polyol which is predominantly, preferably completely, produced from renewable raw materials and which is especially suitable for producing rigid PUR/PIR foams since it exhibits comparable or even improved characteristics compared to hitherto commercially available polyols based on fossil raw materials. In the abovementioned generalized structural formula of the polyol, n may especially assume positive values between 1.0 and 10.0, advantageously between 1.0 and 7.0, particularly advantageously between 1.0 and 5.0, by preference between 1.0 and 4.0, preferably between 2.0 and 4.0. It is particularly preferable when n has a value between 2.0 and 3.0. Positive values greater than 10.0 are in principle also conceivable for n. In the present case the specified value ranges of n relate to macromolecules of the polyol and therefore represent statistical averages.

The invention additionally relates to a method for producing rigid PUR/PIR foams, in particular according to any of the above-described embodiments, wherein at least one polyisocyanate, at least one polyol synthesized at least partially from renewable raw materials, in particular by any of the above-described processes for synthesizing the polyol, and at least one blowing agent are converted into a rigid PUR/PIR foam. Such a method advantageously makes it possible to achieve a particularly sustainable production of rigid PUR/PIR foams. Without being limited thereto the polyisocyanate may for example be polymeric diphenylmethane diisocyanate (PMDI) and/or methylene diphenyl isocyanate (MDI) and/or hexamethylene diisocyanate (HDI) and/or tolylene diisocyanate (TDI) and/or naphthylene diisocyanate (NDI) and/or isophorone diisocyanate (IPDI) and/or 4,4′-diisocyanatodicyclohexylmethane (H12MDI). The polyisocyanate is preferably polymeric diphenylmethane diisocyanate (PMDI). The blowing agent is preferably pentane. Also conceivable in principle as blowing agents, alternatively or in addition, would be CO₂ which is formed during the addition of water by reaction with the isocyanate component and/or partially fluorinated hydrocarbons, for example HFKW-365mfc and HFKW-245fa. The method may additionally employ further additives, in particular flame retardants and/or activators and/or emulsifiers and/or foam stabilizers and/or further additives that appear useful to those skilled in the art. The use of catalysts in the method is also conceivable. Polyurethanes are formed in the process by a polyaddition reaction of the polyisocyanate with the polyol. The use of an excess of polyisocyanate makes it possible to crosslink linear polyurethanes. Addition of an isocyanate group onto a urethane group forms an allophanate group. Formation of an isocyanurate group is also possible through trimerization of three isocyanate groups. The use of multifunction polyisocyanates results in the formation of highly branched polyisocyanurates (PIR), thus making it possible to obtain rigid PIR foams. The method is preferably used to synthesize rigid PUR/PIR foams having a PIR index of 200 to 400, preferably having a PIR index of 250 to 350 and particularly preferably having a PIR index of 290 to 310.

Further advantages and further embodiments of the present invention are apparent from the following description of the exemplary embodiments and from the claims. A person skilled in the art will advantageously also consider the features recited herein individually and combine them to form appropriate further combinations. It will be appreciated that the aforementioned and hereinbelow-elucidated features of the invention can be used not just in the particular combination recited, but also in other combinations, without departing from the realm of the invention described hereinabove and hereinbelow. In particular a combination of at least one preferred feature with at least one particularly preferred feature or a combination of at least one feature not further characterized with at least one preferred and/or particularly preferred feature is also implicitly comprehended even when such combinations are not explicitly mentioned. The subsequent exemplary embodiments further relate to embodiments of the invention on a laboratory scale so that individual parameters and/or characteristic values from those specified below may be slightly altered during scale-up of the invention to an industrial scale without departing from the hereinabove described or hereinbelow described realm of the invention.

### BRIEF DESCRIPTION OF THE DRAWINGS

FIG. 1 shows an exemplary ¹H-NMR of PDEF, used for determining the conversion of FDCA, the excess of DEG and Xₙ, measured in DMSO-d6;

FIG. 2 shows size exclusion chromatography (SEC) chromatograms of polyols 1-3 of Table 3;

FIG. 3 shows the structural formula and the result of the ¹H-NMR of the polyol according to exemplary embodiment 1 measured in DMSO-d6;

FIG. 4 shows the structural formula and the result of the ¹H-NMR of the polyol according to exemplary embodiment 8 measured in DMSO-d6;

FIG. 5 shows the structural formula and the result of the ¹H-NMR of the polyol according to exemplary embodiment 9 measured in DMSO-d6; and

FIG. 6 shows the structural formula and the result of the ¹H-NMR of the polyol according to exemplary embodiment 10 measured in DMSO-d6.

### DESCRIPTION OF THE EXEMPLARY EMBODIMENTS

Exemplary embodiments of the present invention are specified below, wherein these are not intended to limit the present invention in any way.

The following initially describes in general terms a method for synthesizing a polyol for producing rigid PUR/PIR foams and a method for producing rigid PUR/PIR foams before the individual exemplary embodiments are elucidated in detail.

In the method for synthesizing the polyol for producing rigid PUR/PIR foams from at least one polyhydric alcohol and at least one aromatic dicarboxylic acid, at least partially renewable raw materials are employed as starting materials. In the present case at least one aromatic dicarboxylic acid, namely 2,5-furandicarboxylic acid (FDCA), which is predominantly produced from renewable raw materials is employed. At least one polyhydric alcohol which is predominantly produced from renewable raw materials is also employed. At least one catalyst is further employed. In all exemplary embodiments which follow, the method comprises at least two method steps, wherein a single-stage method or a method having more than two method steps would also be conceivable in principle. In a first method step of the method at least a polyhydric alcohol, in the present case precisely one polyhydric alcohol, is initially charged and preheated. In all exemplary embodiments, in the first method step the polyhydric alcohol is initially charged in an equivalent concentration between 1.75 and 2.00 with respect to the starting concentration of dicarboxylic acid(s) and preheated. In all exemplary embodiments, in a second method step a 2,5-furandicarboxylic acid (FDCA) predominantly produced from renewable raw materials is added as the aromatic dicarboxylic acid. In all exemplary embodiments, in the second method step a reaction mixture of the starting materials is stirred at a temperature between 60° C. and 240° C. The reaction mixture is stirred at speeds between 150 RPM and 450 RPM.

In a number of exemplary embodiments of the method the catalyst employed is a titanium-containing catalyst.

In some exemplary embodiments, at least one further dicarboxylic acid is additionally employed especially to reduce the dynamic viscosity of the polyol to be synthesized.

In one exemplary embodiment, at least one surfactant predominantly produced from renewable raw materials is additionally employed.

The method is performed according to the following generalized reaction scheme:

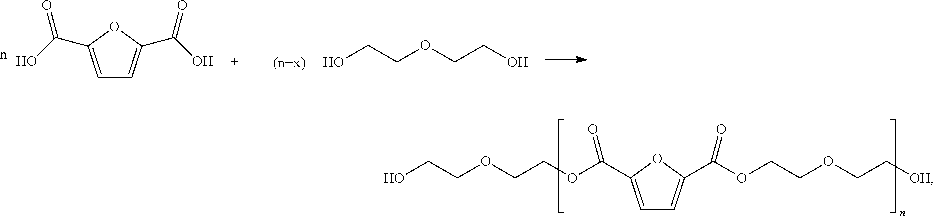

wherein n may especially assume positive values between 1.0 and 10.0 and x may especially assume positive values between 0.0 and 5.0. In some exemplary embodiments, further starting materials and/or catalysts are employed in addition to 2,5-furandicarboxylic acid and diethylene glycol.

The resulting polyol is a poly(diethylene glycol furanoate) (PDEF) which has the following generalized structure:

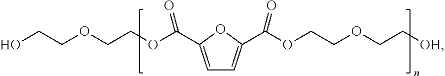

wherein n can especially assume positive values between 1.0 and 10.0. It is preferable when n takes a value between 2 and 3.

The resulting polyol synthesized at least partially from renewable raw materials is subsequently subjected to further processing in a method for producing rigid PUR/PIR foams, wherein at least one polyisocyanate, the polyol synthesized at least partially from renewable raw materials and at least one blowing agent are converted into a rigid PUR/PIR foam.

In the method for producing rigid PUR/PIR foams, methylene diphenyl isocyanate (MDI) is employed as the polyisocyanate and pentane is employed as the blowing agent. In the method for producing rigid PUR/PIR foams on a laboratory scale the polyol, at least one flame retardant, at least one catalyst, at least one foam stabilizer and water are added to a beaker and premixed. The pentane is then added and the mixture mixed again. The polyisocyanate is subsequently added and stirred at 2000 RPM for at least 20 seconds with a laboratory mixer. The reaction mixture is subsequently poured into a lined wooden foaming mold having dimensions of 20×20×20 cm³ and covered with a lid. The rigid PUR/PIR foam is synthesized with a PIR index of 200 to 400, preferably 250 to 350, particularly preferably about 300.

### MATERIALS

The experiments described in the present application employed the following chemicals as obtained: 2,5-furandicarboxylic acid (FDCA, 98%, BLDpharm), adipic acid (AA, 99%, Acros Organics), dibutyltin(IV) oxide (98%, Sigma Aldrich), Brij® L4 (Sigma Aldrich), CATALYST LB (Huntsman), DABCO® TMR13 (Evonik), Desmodur® 44V70L (Covestro), Desmophen® V657 (Covestro), diethylene glycol (DEG, 99%, chemPUR), dimethylsulfoxide-d6 (DMSO-d6, 99.9 atom % D, Sigma Aldrich), pentane (60% cyclohexane, 40% isopentane, Julius Hoesch), phthalic acid (>99.5%, Sigma Aldrich), POLYCAT® 36 (Evonik), STRUKSILON KOCT 15 (Schill+Seilacher), succinic acid (SA, 99%, Acros Organics), TEGOSTAB® B84510 (Evonik), tetraisopropyl orthotitanate (97%, Sigma Aldrich), triethyl phosphate (TEP, PROCHEMA), tris(chlorisopropyl) phosphate (TCPP, PROCHEMA).

### PRELIMINARY EXPERIMENTS

Since a poly(diethylene glycol furanoate) (PDEF) is to be obtained as a processable oil for producing rigid PUR/PIR foams, preliminary tests were initially performed to optimize the reaction conditions. It was found that the use of ethylene glycol (EG) as the polyhydric alcohol resulted in solid polyols which were unprocessable for the production of rigid PUR/PIR foams and therefore the exemplary embodiments described hereinbelow employ diethylene glycol (DEG) instead of ethylene glycol (EG) as the polyhydric alcohol. The exemplary embodiments described below are moreover based on the following considerations: Typical OH values of commercially available aromatic polyester polyols for production of rigid PUR/PIR foams are 240 mg KOH/g, including the amount of remaining unreacted glycol. A desired molecular weight of the PDEF polyol of about 468 g/mol was thus calculated using the following equation 1:

$${M}_{n} = \frac{z * 56 , 106 [ \frac{g}{mol} ]}{OH [ \frac{mg KOH}{g} ]} \qquad ( 1 )$$

wherein Mₙ is the molecular weight of the polyol, z is the functionality of the polyol, and OH is the OH number of the polyol. However, this molecular weight underestimates the molecular weight of the polyester polyol since the excess of glycol is not taken into account in this calculation. The degree of polymerization Xₙ for the investigated poly(diethylene glycol furanoate) was additionally calculated as 1.6 using the following equation:

$${X}_{n} = \frac{{M}_{n} - {M}_{end grop}}{{M}_{repeating unit}} \qquad ( 2 )$$

wherein M_{end group} is the molecular weight of the end group and M_{repeating unit} is the molecular weight of the repeating unit. According to the Carothers equation for A-A/B-B systems, which is shown below as equation 3, the stoichiometric ratio of diethylene glycol to 2,5-furandicarboxylic acid was calculated for p=1 with r=0.24:

$${X}_{n} = \frac{1 + r}{1 + r - 2 p r} \qquad ( 3 )$$

wherein:

$$r = \frac{{N}_{A}}{{N}_{B}} < 1$$

and wherein r is a ratio between a number of molecules NA and a number of molecules NB and p is a conversion. However, for all practical purposes the assumption made in the last calculation was unsuitable since complete conversion (p=1) could not be ensured and even small differences in the conversion have a considerable effect on the observed molecular weight. In addition, the condensate requires continuous removal to achieve high conversions, with partial evaporation of diethylene glycol with the water formed also occurring. The initial molar ratio will therefore change during the reaction, with a resulting effect on the molecular weight. The values calculated above therefore provide a valuable starting point for the investigated polymerization but the reaction conditions must be optimized by varying the amount of diethylene glycol to obtain a low glycol excess, the desired molecular weight and a still-processable viscosity.

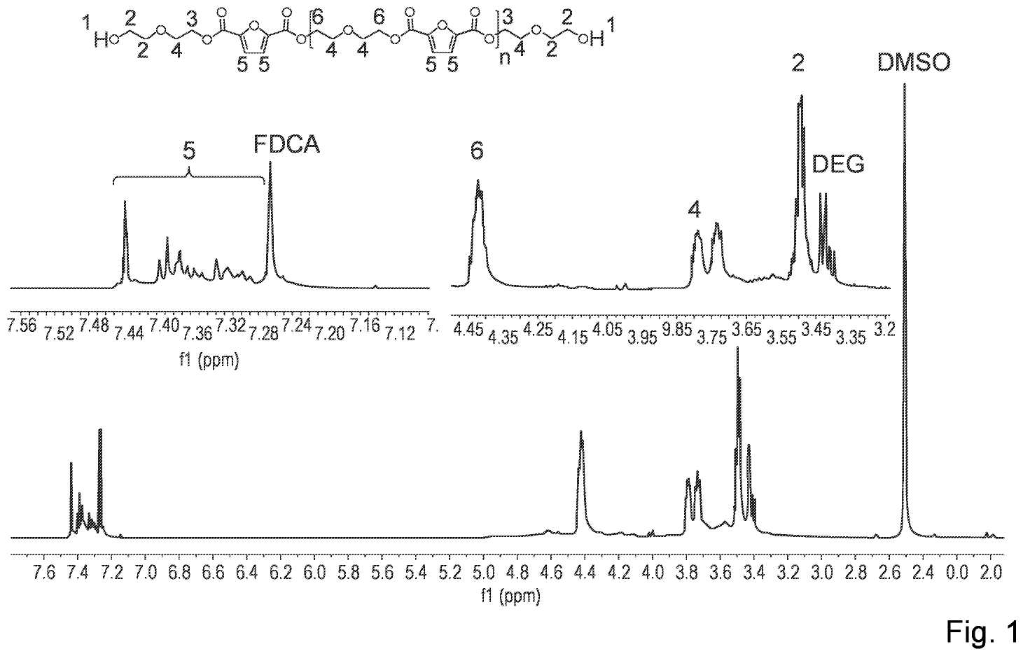

Reaction monitoring was performed using ¹H-NMR as shown in FIG. 1. The conversion of 2,5-furandicarboxylic acid will be determined by the ratio of the signals having a chemical shift of 7.27 ppm and 7.30-7.46 ppm, as illustrated in the following equation 4:

$$Umsatz [ \% ] = ( 1 - \frac{\int {H}_{7.27 ppm}}{\int {H}_{7.30 - 7.46 ppm} + \int {H}_{7.27 ppm}} ) * 100 \% \qquad ( 4 )$$

In addition the degree of polymerization was calculated using the two signals of the assigned CH₂ group of the diethylene glycol unit in the polymer backbone and the end group at 3.80 ppm and 3.70 ppm respectively using the following equation 5:

$${X}_{n} = 1 + \frac{\int {H}_{3.8 ppm ( repeating unit )}}{\int {H}_{3.7 ppm ( end group )}} \qquad ( 5 )$$

The calculation of Xₙ via ¹H-NMR with Xₙ=1 for n=0 was normalized over the aromatic protons of the furan repeating unit.

The excess of unreacted diethylene glycol (DEG) was calculated via the isolated signal of the O(CH₂CH₂OH)2 protons having a chemical shift of 3.40 ppm using the following equation 6:

$$wt \% ( excess DEG ) = ( \frac{\int \frac{{H}_{DEG}}{4} * ( {n}_{FDCA} + {n}_{comonomer} ) * {M}_{DEG}}{\sum {m}_{reactants}} ) * 100 \% \qquad ( 6 )$$

The calculation of the DEG excess over ¹H-NMR in % by weight was normalized over the aromatic protons of the furan repeating unit.

FIG. 1 shows an exemplary ¹H-NMR of PDEF, used for determining the conversion of FDCA, the excess of DEG and Xₙ, measured in DMSO-d6.

Different catalysts for the polymerization were initially investigated. Tin catalysts are often employed in industry due to their high catalytic activity in esterification and transesterification reactions. Dibutyltin(IV) oxide (SnOBu2) also showed good results for the presently investigated system, wherein almost complete conversion of FDCA (>98%) was achieved after 4 hours. Tetraisopropyl orthotitanate (Ti(O^{I} Pr)₄) is today a typical catalyst for the industrial synthesis of many different esterification and transesterification products. This catalyst likewise showed good catalytic activity, wherein almost complete conversion of FDCA (>99%) was achieved after 24 hours. In a reference reaction without catalyst only 70% of FDCA was converted after 24 hours, thus clearly showing that the use of a catalyst is advantageous. From a sustainability standpoint tin catalysts are highly toxic and dangerous. Since they remain in the finished polyol this catalyst was of no further interest. Since tetraisopropyl orthotitanate represents a good compromise between catalytic activity and sustainability this catalyst was used for further investigations.

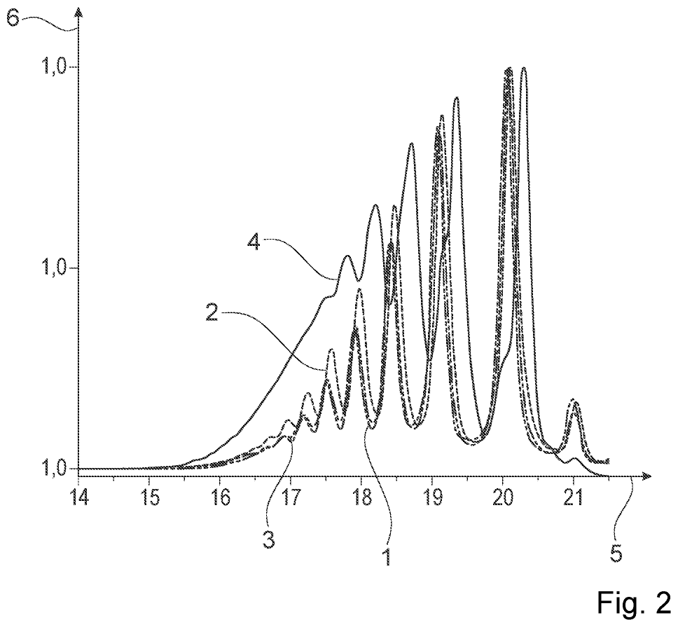

As described above, the molar ratio of DEG to FDCA had to be experimentally adapted to find the best match between full conversion, desired Xₙ and low excess of DEG. A commercially available aromatic polyester polyol based on phthalic acid (PDEP, cf. FIG. 2, polyol 4) was selected as the reference polyol containing 0.50 equivalents of unconverted DEG. The experimental parameters used in the context of the performed preliminary experiments for optimizing the reaction conditions for different equivalent concentrations of diethylene glycol (DEG) are shown in the following table 1:

TABLE 1
Optimization of reaction conditions at different equivalent concentrations of DEG

| | | | | | | Excess | Excess |
|---|---|---|---|---|---|---|---|
| | | | | FDCA | | of DEG | of DEG |
| | | Reaction | | conversion | Xn | (NMR) | (NMR) |
| Entry | Glycol | time | | (NMR) [%] | (NMR) | [wt %] | [eq] |
| 1 | 3.00 eq DEG | 1 | h | 95 | 1.5 | 38 | 1.75 eq |
| 2 | 2.50 eq DEG | 1 | h | 94 | 1.5 | 30 | 1.25 eq |
| 3 | 2.50 eq DEG | 1 | h | 95 | 1.4 | 28 | 1.25 eq |
| | 0.10 eq Brij ® L4 | | | | | | |
| 4 | 2.50 eq DEG | 35 | min | 85 | 1.5 | 28 | 1.00 eq |

The experiments designated as entries 1 to 4 in table 1 in each case employed 1.00 equivalents of 2,5-furandicarboxylic acid (FDCA) and 5 mol % of tetraisopropyl orthotitanate. The reactions were each performed at 160° C.

During this experimental series the reaction was stopped as soon as the heterogeneous solution of FDCA and DEG became a homogeneous melt. At this time a high conversion of FDCA into the corresponding esters having melting points below 160° C. was observed. After 1 hour, 95% of the FDCA had already been converted with 3.00 equivalents of DEG (cf. entry 1, table 1) as determined by ¹H-NMR via the ratio of the signals having a chemical shift of 7.27 ppm and 7.30-7.46 ppm, respectively, as shown in FIG. 1. In addition, at 1.5, the degree of polymerization Xₙ was close to the desired calculated value but under these conditions 1.75 equivalents of unreacted DEG remained in the polyol (cf. entry 1, table 1). Xₙ and the excess of DEG were calculated as described above using the signals having a chemical shift of 3.70 ppm, 3.80 ppm and 3.40 ppm in the corresponding proton NMR (cf. FIG. 1). If only 2.50 equivalents of DEG were employed the same conversions and Xₙ were observed while the excess of DEG was reduced to 1.25 equivalents (cf. entry 2, table 1). Entry 3 in table 1 shows that polyethylene glycol dodecyl ether, which is available under the trade name Brij® L4, may also be added as a surfactant to reduce viscosity without any adverse effects on the reaction system. The slightly lower Xₙ value can be explained by the chemical structure of the surfactant, which bears an OH group and thus acts as a chain terminator in the polycondensation. The total amount of reactive OH groups is also slightly higher compared to entry 2. The best results were achieved with 2.00 equivalents of DEG, as shown in entry 4 of table 1, wherein the excess of DEG was reduced to 1.00 equivalents. Since a homogeneous solution was observed even after 35 minutes, only 85% of the dicarboxylic acid was converted and so the amount of unconverted DEG can be further reduced for higher conversions. At longer reaction times the conversion of FTCA can be enhanced to 99% which is accompanied by an elevated Xₙ of 1.7 while the excess of DEG was reduced to 0.75 equivalents after 2.5 hours.

The viscosity of the polyol may be further reduced by copolymerization of bio-based aliphatic dicarboxylic acids such as succinic acid (SA) or adipic acid (AA) while retaining the fully bio-based character of the polyol. The reaction conditions of corresponding preliminary experiments are shown in table 2:

TABLE 2
Copolymerization of various dicarboxylic acids with FDCA

| | | FDCA/comonomer | | Excess | Excess |
|---|---|---|---|---|---|
| | | conversion | | of DEG | of DEG |
| | | (NMR) | Xn | (NMR) | (NMR) |
| Entry | Comonomer | [%] | (NMR) | [wt %] | [eq] |
| 1 | 0.2 eq AA | >99/>99 | 1.6 | 21 | 0.75 eq |
| 2 | 0.2 eq SA | 95/>99 | 1.6 | 25 | 0.9 eq |
| 3 | 0.2 eq PA | >99/>99 | / | 15 | 0.55 eq |

Entries 1 and 2 in table 2 showed an almost complete conversion of 2,5-furandicarboxylic acid (FDCA) and succinic acid (SA) or adipic acid (AA) while the degree of polymerization was as desired. In the approach with succinic acid the DEG excess was somewhat higher which is attributable to incompletely converted FDCA. Longer reaction times were generally required compared to the results described in table 1, this being attributable to a scale-up to almost 5.00 g of dicarboxylic acid, and mixing with a magnetic stirrer was more difficult. A further approach was the copolymerization of phthalic acid (PA) to retain the fully aromatic character of the dicarboxylic acid. In this case the polyol is no longer completely bio-based due to the petroleum-based phthalic acid. Entry 3 in table 2 showed complete conversion of FDCA and PA at an excess of 0.55 equivalents of DEG. However, the degree of polymerization was not determinable due to overlapping of the signals in the proton NMR. Since a completely bio-based character is sought the copolymerization of an aromatic petroleum-based carboxylic acid was not further investigated.

For the subsequent PU synthesis the next step performed was a scale-up of selected reactions to up to 100 g of dicarboxylic acid which was achieved using the optimized conditions for a homopolymer of FDCA (polyol 1) and copolymers comprising 10 mol % of either succinic acid (polyol 2) or adipic acid (polyol 3). The scale-up experiments are shown in table 3:

TABLE 3
Scale-up reactions of polyol synthesis using 2,5-furandicarboxylic
acid and 10 mol % of succinic acid or adipic acid.

| | | | | | OH (NMR) | OH |
|---|---|---|---|---|---|---|
| | | | Excess | Excess | without | (measured) |
| | | | of DEG | of DEG | excess | with excess |
| | Dicarboxylic | Xn | (NMR) | (NMR) | of DEG | of DEG |
| Polyol | acid | (NMR) | [wt %] | [eq] | [mg KOH/g] | [mg KOH/g] |
| 1 | 1.00 eq FDCA | 1.8 | 19 | 0.7 | 210 | 364 |
| 2 | 0.90 eq FDCA | 2.0 | 17 | 0.6 | 220 | 330 |
| | 0.10 eq SA | | | | | |
| 3 | 0.90 eq FDCA | 1.7 | 20 | 0.7 | 230 | 350 |
| | 0.10 eq AA | | | | | |
| 4 | PA | / | 16 | 0.5 | / | 24β |

In the present case the polycondensation was stirred for 2 to 6 days to ensure complete conversion of the carboxylic acid groups since otherwise the amine catalyst for PU foam would be deactivated, as was also observed here. Laboratory-scale mixing for these scale-up reactions was less efficient than on a smaller scale. But even after these long reaction times the Xₙ value remained in the region of the desired value, thus indicating good control of molecular weight under the optimized reaction conditions. The size exclusion chromatography (SEC) chromatograms of the polyols 1-3, shown in FIG. 2, confirm this observation. A residence time in minutes is plotted on an abscissa 5 of the diagram in FIG. 2. A normalized detector signal I is plotted on an ordinate of the diagram.

Furthermore, the amount of unreacted DEG was at a similarly high level to commercial polyol 4. As mentioned above, the desired degree of polymerization was slightly underestimated since the measured OH values already took into account the excess of DEG remaining in the polyol. This is clearly apparent from a comparison of the SEC chromatograms of the commercial polyol 4 and the completely bio-based polyols 1 to 3 (cf. FIG. 2). A comparison of the OH values without DEG determined by proton NMR and the measured values including unconverted DEG is shown in table 3. As expected, the measured values of 300-350 mg KOH/g were higher than those of the commercial polyol 4 but necessary for this system in particular since higher Xₙ resulted in high-viscosity and thus unprocessable PDEF. In addition, the OH values obtained by ¹H-NMR may be correlated with the measured values, thus demonstrating the suitability of this method.

In a next step the completely bio-based polyols 1 to 3 were processed with methylene diphenyl diisocyanate (MDI) to form rigid PIR foams. All three polyols showed a suitable reactivity since a good and very rapid foaming occurred, even compared to the commercial polyol. The reaction between polyol 1 and methylene diphenyl isocyanate (MDI) began 20 seconds after mixing of the two components, while foaming was complete after 50 seconds. Polyols 2 and 3 showed a similar reactivity. All foams showed very rapid curing.

Finally, important properties of the obtained rigid PIR foams were investigated. These properties are summarized in table 4:

TABLE 4
Thermal and mechanical properties of the rigid
PIR foam for the various polyols 1-4.

| | | | | Highest flame | |
|---|---|---|---|---|---|
| | | | | height within | |
| | | Density | λ_{23° C.} | 20 seconds | σₘ³ |
| Entry | Polyol | [kg/m³] | [mW/m*K] | [cm] | [KPa] |
| 1 | 0.85 eq polyol 4 | 33.4 | 23.4 | 10 | 283 |
| | 0.15 eq polyol 5 | | | | |
| 2 | 0.85 eq polyol 1 | 33.4 | 23.1 | 13 | 296 |
| | 0.15 eq polyol 5 | | | | |
| 3 | 0.85 eq polyol 2 | 32.4 | 23.5 | 13 | 300 |
| | 0.15 eq polyol 5 | | | | |
| 4 | 0.85 eq polyol 3 | 32.3 | 23.9 | 13 | 309 |
| | 0.15 eq polyol 5 | | | | |

All PIR foams were synthesized with a PIR index of about 300 using the above-described process. In this method up to 15 mol % of a commercially available trifunctional polyether polyol were in some cases added for improved miscibility. The obtained PIR foam from polyol 1 showed a similar thermal conductivity at 23° C. (λ23° C.) of 23.1 mW/m*K and a compressive strength in the rise direction (σₘ) of 296 kPa compared to commercial polyol 4 (23.4 mW/m*K, 283 kPa) and an identical density of 33.4 kg/m3 (cf. table 4, entries 1 and 2). The thermal conductivity values reported in table 4 refer to measurements of PIR foams produced on a laboratory scale at 23° C. In the case of scale-up of the method for producing PIR foams on an industrial scale it is assumed, based on prior experience, that the thermal conductivities will be about 3 mW/m*K lower. This is because, as is known from experience, PIR foams produced on an industrial scale have a finer cell structure and because the thermal conductivities of PIR foams produced on an industrial scale are determined according to the standard DIN EN 12667 at a measurement temperature of 10° C.

The fire characteristics were slightly better for the commercially available polyol 4, as explicable by a higher oxygen content of polyol 1 on account of the furan ring in the polyester backbone (cf. table 4, entries 1 and 2). The PIR foam nevertheless passed the fire characteristics test in class B2 according to DIN 4102 and class E according to DIN EN ISO 11925-2 (experimental part). Furthermore, the influence of 10 mol % of bio-based aliphatic carboxylic acid made of polyols 2 and 3 compared to polyol 1 in the PIR foams was only marginal. Density was slightly lower while thermal conductivity and Om were slightly elevated at identical flame characteristics.

### EXEMPLARY EMBODIMENT 1

In a first method step of a method for synthesizing a polyol for production of rigid PUR/PIR foams according to exemplary embodiment 1, 121 mL of diethylene glycol (136 g, 1.28 mol) as polyhydric alcohol are initially charged in a 500 mL three-necked flask fitted with a KPG stirrer and preheated at 160° C. for 30 minutes. Subsequently, in a second method step 100 g of 2,5-furandicarboxylic acid (641 mmol, 1.00 eq) as aromatic dicarboxylic acid predominantly produced from renewable raw materials and 9.48 mL of tetraisopropyl orthotitanate (9.10 g, 32.0 mmol) as titanium-containing catalyst were added to the three-necked flask. With respect to the starting concentration of the 2,5-furandicarboxylic acid, in the present exemplary embodiment the equivalent concentration of the diethylene glycol has a value of 2.00 and the equivalent concentration of the tetraisopropyl orthotitanate has a value of 0.05. The resulting reaction mixture is subsequently stirred at 160° C. for 67 hours and at speeds of 150 RPM to 450 RPM. The resulting condensate is continuously distilled off. The method according to exemplary embodiment 1 is summarized again in the following schematic reaction scheme:

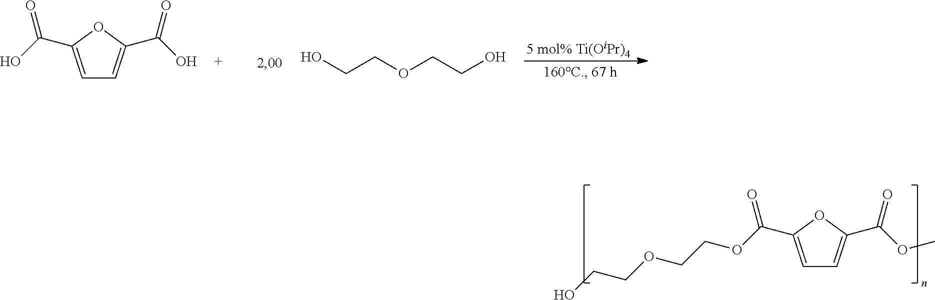

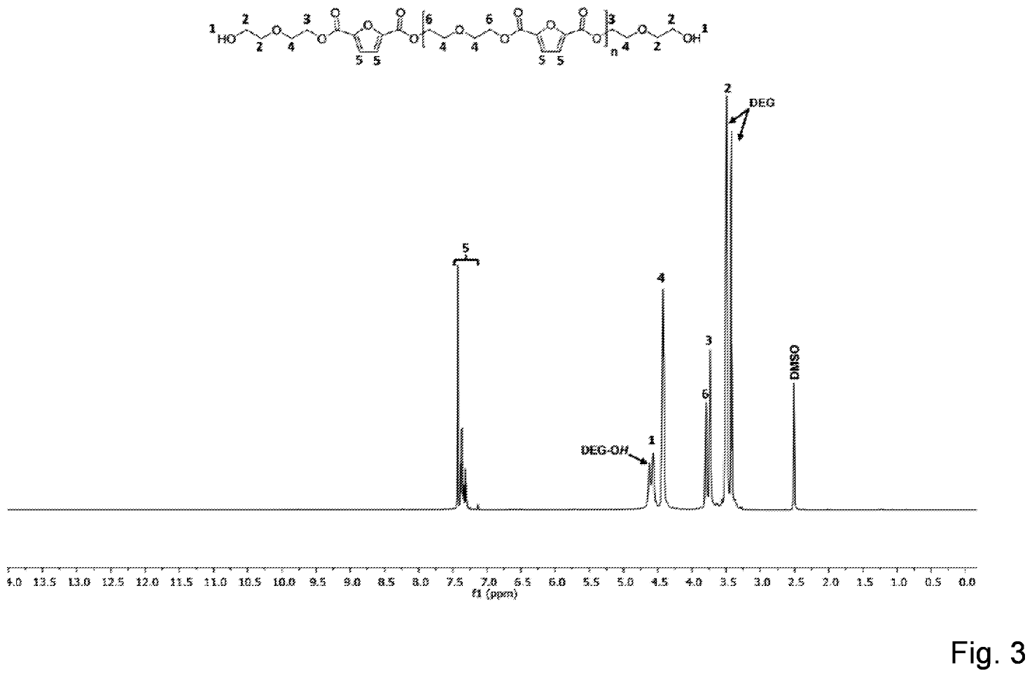

The reaction process is monitored by ¹H-NMR and the reaction is stopped as soon as complete conversion of the 2,5-furandicarboxylic acid is observed. FIG. 3 shows the structural formula and the result of the ¹H-NMR of the polyol according to exemplary embodiment 1 measured in DMSO-d6.

The ¹H-NMR data are as follows:

¹H-NMR (500 MHz, DMSO-d6): δ/ppm=7.28-7.44 (m, H₅), 4.61 (s, O(CH₂CH₂OH)₂), 4.56 (s, OCH₂CH₂OH¹), 4.38-4.44 (m, OCH₂CH₂⁴O), 3.76-3.81 (m, OCH₂⁶CH₂OCHO), 3.70-3.75 (m, OCH₂³CH₂OCHO), 3.45-3.53 (m, OCH₂₂CH₂²OH+O(CH₂CH₂OH)₂), 3.38-3.43 (m, O(CH₂CH₂OH)₂).

Carbon-13 (C13) nuclear magnetic resonance was also performed with the following results:

¹³C-NMR (126 MHZ, DMSO-d6): δ/ppm=157.2-157.5, 146.0-146.2, 119.0-119.4, 72.37, 72.33, 64.55-64.65, 64.23-64.33, 60.32, 60.24.

Infrared spectroscopy was also performed with the following results:

IR (ATR platinum diamond): v/cm⁻¹=3394, 2873, 1716, 1581, 1509, 1452, 1382, 1271, 1223, 1120, 1060, 1020, 965, 924, 890, 827, 765, 618, 480.

The polyol synthesized in this way is at least partially produced from renewable raw materials. At least the aromatic dicarboxylic acid, which is 2,5-furandicarboxylic acid (FDCA), is predominantly produced, namely to a proportion of at least 98% by weight, from renewable raw materials. In the present case the polyhydric alcohol diethylene glycol is also predominantly produced, namely to a proportion of more than 50% by weight, from renewable raw materials. The polyol has an OH number of greater than 250 mg KOH/g and less than 400 mg KOH/g. In the present case an OH number of the polyol is 322 mg KOH/g. The polyol has a content of free glycol of more than 6% by weight and less than 20% by weight with respect to its total mass. The polyol has an average molar mass of less than 1000 g/mol. In the present case the average molar mass of the polyol is 870 g/mol. The polyol has a dynamic viscosity between 3000 mPas and 12 000 mPas.

Subsequently a rigid PUR/PIR foam is produced from the polyol synthesized by the method together with methylene diphenyl isocyanate (MDI) as the polyisocyanate and pentane as the blowing agent using a method for producing rigid PUR/PIR foams. The rigid PUR/PIR foam produced by this method has a bulk density of 30.2 kg/m³. A measured thermal conductivity of the rigid PUR/PIR foam is 0.0209 W/(mK), the measured value being determined on the laboratory foam at an average temperature of 23° C. Production plant foams, measured at an average temperature of 10° C., have a thermal conductivity that is about 0.002 to 0.003 W/(mK) lower. The fire characteristics of the produced rigid PUR/PIR foam meet building material class E according to DIN EN ISO 11925-2.

### EXEMPLARY EMBODIMENT 2

In a first method step of a method for synthesizing a polyol for production of rigid PUR/PIR foams according to exemplary embodiment 2, 5.31 mL of diethylene glycol (corresponds to 5.95 g, 56.1 mmol) as polyhydric alcohol are initially charged in a 50 mL round-bottom flask fitted with a magnetic stirrer and preheated at 160° C. for 30 minutes. Subsequently, 5.00 g of 2,5-furandicarboxylic acid (32.0 mmol, 1.00 eq) and 474 μL of tetraisopropyl orthotitanate (455 mg, 1.60 mmol) as a titanium-containing catalyst are added in a second method step of the process. In a departure from the preceding exemplary embodiment, in present exemplary embodiment 2 the equivalent concentration of the diethylene glycol with respect to the concentration of the 2,5-furandicarboxylic acid has a value of 1.75. The equivalent concentration of tetraisopropyl orthotitanate with respect to the concentration of 2,5-furandicarboxylic acid is unchanged at a value of 0.05. The reaction mixture is then stirred at 160° C. for 26 hours. The resulting condensate is continuously distilled off. The method according to exemplary embodiment 2 is summarized again in the following schematic reaction scheme:

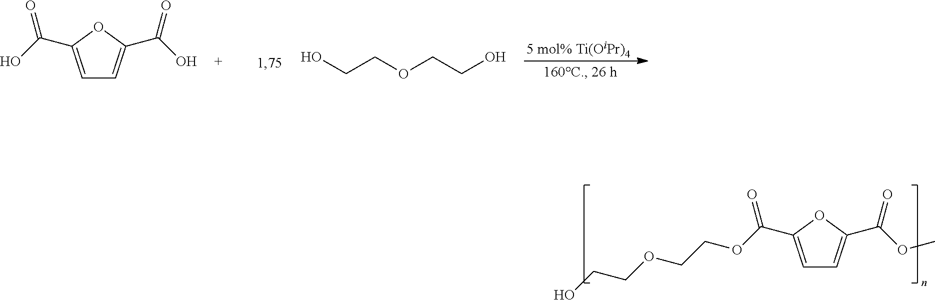

The polyol synthesized by the method is at least partially produced from renewable raw materials. At least the aromatic dicarboxylic acid, which is 2,5-furandicarboxylic acid (FDCA), is predominantly produced, namely to a proportion of at least 97% by weight, from renewable raw materials. In the present case the polyhydric alcohol diethylene glycol is also predominantly produced, namely to a proportion of more than 50% by weight, from renewable raw materials. The polyol has an OH number of greater than 250 mg KOH/g and less than 400 mg KOH/g. The polyol has a content of free glycol of more than 6% by weight and less than 20% by weight with respect to its total mass. The polyol has an average molar mass of less than 1000 g/mol. In the present case the polyol has an average molar mass of 760 g/mol. The polyol has a dynamic viscosity between 3000 mPas and 12 000 mPas.

An above-described method for producing rigid PUR/PIR foams makes it possible to produce a rigid PUR/PIR foam having the required properties from the synthesized polyol together with at least one polyisocyanate and at least one blowing agent.

### EXEMPLARY EMBODIMENT 3

In a first method step of a method for synthesizing a polyol for production of rigid PUR/PIR foams according to exemplary embodiment 3, 5.31 mL of diethylene glycol (5.95 g, 56.1 mmol) are initially charged in a 50 mL round-bottom flask fitted with a magnetic stirrer and preheated at 160° C. for 30 minutes. In a subsequent second method step of the method 5.00 g of 2,5-furandicarboxylic acid (32.0 mmol, 1.00 eq) as aromatic dicarboxylic acid predominantly produced, namely to a proportion of at least 98% by weight, from renewable raw materials and 474 μL of tetraisopropyl orthotitanate (455 mg, 1.60 mmol) as titanium-containing catalyst are added. Also added in the second method step is a surfactant predominantly produced, namely to a proportion of more than 50% by weight, from renewable raw materials, namely 1.21 mL of polyethylene glycol dodecyl ether (1.16 g, 3.20 mmol) which is obtainable predominantly from renewable raw materials under the trade name Brij® L4. With respect to the starting concentration of the 2,5-furandicarboxylic acid, in the present exemplary embodiment the equivalent concentration of the diethylene glycol has a value of 1.75, the equivalent concentration of the tetraisopropyl orthotitanate has a value of 0.05 and the equivalent concentration of the polyethylene glycol dodecyl ether has a value of 0.10. In the second method step the reaction mixture is subsequently stirred at 160° C. for 32 hours and at speeds of 150 RPM to 450 RPM. The resulting condensate is continuously distilled off. The method according to exemplary embodiment 3 is summarized again in the following schematic reaction scheme:

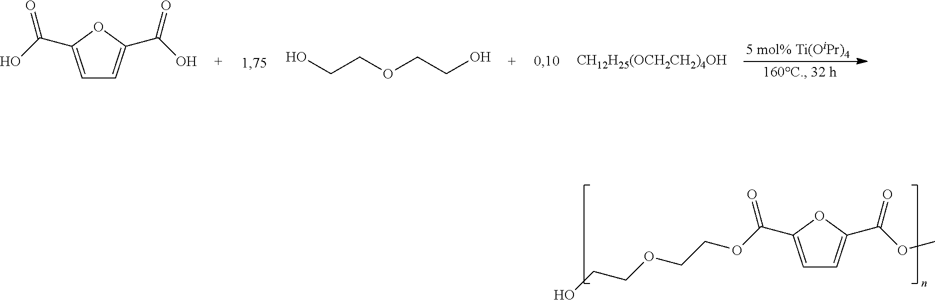

The polyol synthesized by the method is at least partially produced from renewable raw materials. At least the aromatic dicarboxylic acid, which is 2,5-furandicarboxylic acid (FDCA), is predominantly produced, namely to a proportion of at least 98% by weight, from renewable raw materials. In the present case the polyhydric alcohol diethylene glycol is also predominantly produced, namely to a proportion of more than 50% by weight, from renewable raw materials. The polyol has an OH number of greater than 250 mg KOH/g and less than 400 mg KOH/g. The polyol has a content of free glycol of more than 6% by weight and less than 20% by weight with respect to its total mass. The polyol has an average molar mass of less than 1000 g/mol. In the present case the polyol has an average molar mass of 800 g/mol. The polyol has a dynamic viscosity between 3000 mPas and 12 000 mPas. In the present case the polyol has a dynamic viscosity between 4000 mPas and 8000 mPas.

An above-described method according to the invention for producing rigid PUR/PIR foams makes it possible to produce a rigid PUR/PIR foam having the required properties from the synthesized polyol together with at least one polyisocyanate and at least one blowing agent.

### EXEMPLARY EMBODIMENT 4

In a first method step of a method for synthesizing a polyol for production of rigid PUR/PIR foams according to exemplary embodiment 4, 6.07 mL of diethylene glycol (6.80 g, 64.1 mmol) are initially charged in a 50 mL round-bottom flask fitted with a magnetic stirrer and preheated at 160° C. for 30 minutes. Subsequently added in a second method step of the method are 4.00 g of 2,5-furandicarboxylic acid (25.6 mmol, 0.80 eq) as aromatic dicarboxylic acid predominantly produced from renewable raw materials and also a further dicarboxylic acid which is predominantly produced from renewable raw materials, namely 757 mg of succinic acid (6.41 mmol, 0.20 eq). 474 μL of tetraisopropyl orthotitanate (455 mg, 1.60 mmol) as titanium-containing catalyst are also added in the second method step. With respect to the starting concentration of dicarboxylic acids, in the present exemplary embodiment the equivalent concentration of the diethylene glycol has a value of 2.00 and the equivalent concentration of the tetraisopropyl orthotitanate has a value of 0.05. The resulting reaction mixture is subsequently stirred at 160° C. for 44 hours and at speeds of 150 RPM to 450 RPM. The resulting condensate is continuously distilled off. The method according to exemplary embodiment 1 is summarized again in the following schematic reaction scheme:

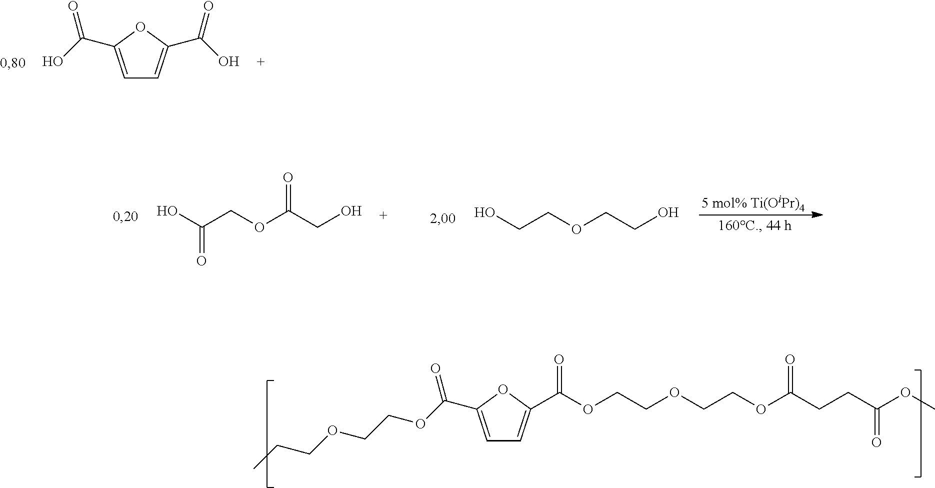

The polyol synthesized in this way is at least partially produced from renewable raw materials. At least the aromatic dicarboxylic acid, which is 2,5-furandicarboxylic acid (FDCA), is predominantly produced, namely to a proportion of at least 98% by weight, from renewable raw materials. In the present case the polyhydric alcohol diethylene glycol is also predominantly produced, namely to a proportion of more than 50% by weight, from renewable raw materials. The polyol has an OH number of greater than 250 mg KOH/g and less than 400 mg KOH/g. The polyol has a content of free glycol of more than 6% by weight and less than 20% by weight with respect to its total mass. The polyol has an average molar mass of less than 1000 g/mol. The polyol has a dynamic viscosity between 3000 mPas and 12 000 mPas. In the present case the polyol has a dynamic viscosity between 4000 mPas and 8000 mPas. The polyol is synthesized at least partially from at least one further dicarboxylic acid, wherein the further dicarboxylic acid, in the present case succinic acid, is an aliphatic dicarboxylic acid which is predominantly produced, namely to a proportion of more than 50% by weight, from renewable raw materials.

An above-described method for producing rigid PUR/PIR foams makes it possible to produce a rigid PUR/PIR foam having the required properties from the synthesized polyol together with at least one polyisocyanate and at least one blowing agent.

### EXEMPLARY EMBODIMENT 5

In a first method step of a method for synthesizing a polyol for production of rigid PUR/PIR foams according to exemplary embodiment 5, 6.07 mL of diethylene glycol (6.80 g, 64.1 mmol) are initially charged in a 50 mL round-bottom flask fitted with a magnetic stirrer and preheated at 160° C. for 30 minutes. In a second method step of the method 4.00 g of 2,5-furandicarboxylic acid (25.6 mmol, 0.80 eq) as aromatic dicarboxylic acid predominantly produced from renewable raw materials and also a further dicarboxylic acid, namely 1.06 g of phthalic acid (6.41 mmol, 0.20 eq), are added. 474 μL of tetraisopropyl orthotitanate (455 mg, 1.60 mmol) as titanium-containing catalyst are additionally added. With respect to the starting concentration of dicarboxylic acids, in the present exemplary embodiment the equivalent concentration of the diethylene glycol has a value of 2.00 and the equivalent concentration of the tetraisopropyl orthotitanate has a value of 0.05. The resulting reaction mixture is subsequently stirred at 160° C. for 51 hours and at speeds of 150 RPM to 450 RPM. The resulting condensate is continuously distilled off. The method according to exemplary embodiment 1 is summarized again in the following schematic reaction scheme:

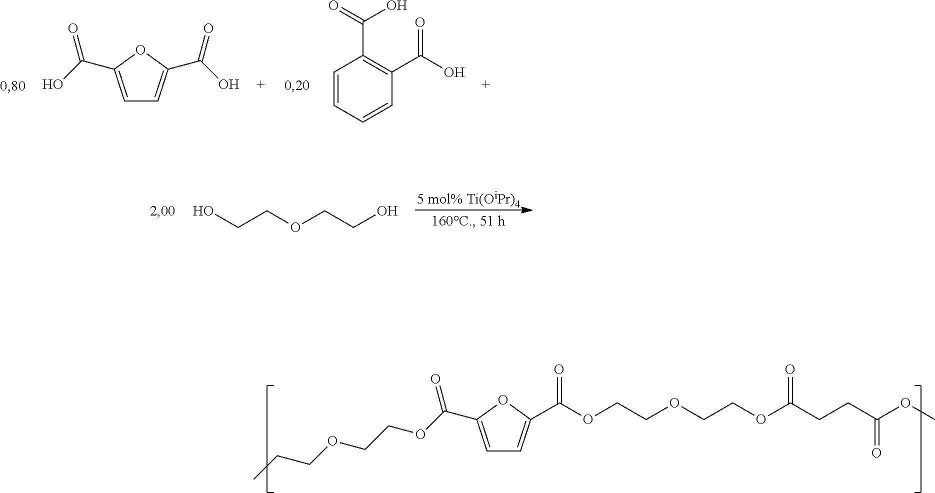

The polyol synthesized by the method is at least partially produced from renewable raw materials. At least the aromatic dicarboxylic acid, which is 2,5-furandicarboxylic acid (FDCA), is predominantly produced, namely to a proportion of at least 98% by weight, from renewable raw materials. In the present case the polyhydric alcohol diethylene glycol is predominantly produced, namely to a proportion of at least 50% by weight, from renewable raw materials. The polyol is synthesized at least partially from at least one further dicarboxylic acid, wherein in the present case this is phthalic acid. The polyol has an OH number of greater than 250 mg KOH/g and less than 400 mg KOH/g. The polyol has a content of free glycol of more than 6% by weight and less than 20% by weight with respect to its total mass. The polyol has an average molar mass of less than 1000 g/mol. The polyol has a dynamic viscosity between 3000 mPas and 12 000 mPas. In the present case the polyol has a dynamic viscosity between 4000 mPas and 8000 mPas.

An above-described method for producing rigid PUR/PIR foams makes it possible to produce a rigid PUR/PIR foam having the required properties from the synthesized polyol together with at least one polyisocyanate and at least one blowing agent.

### EXEMPLARY EMBODIMENT 6

In a first method step of a method for synthesizing a polyol for production of rigid PUR/PIR foams according to exemplary embodiment 6, 6.07 mL of diethylene glycol (6.80 g, 64.1 mmol) are initially charged in a 50 mL round-bottom flask fitted with a magnetic stirrer and preheated at 160° C. for 30 minutes. In a second method step of the method 5.00 g of 2,5-furandicarboxylic acid (32.0 mmol, 1.00 eq) are then added. In a departure from the preceding exemplary embodiments, in the second method step 551 μL of titanium tetrabutoxide (545 mg, 1.60 mmol) as titanium-containing catalyst are added. With respect to the starting concentration of the 2,5-furandicarboxylic acid, in the present exemplary embodiment the equivalent concentration of the diethylene glycol has a value of 2.00 and the equivalent concentration of the titanium tetrabutoxide has a value of 0.05. The resulting reaction mixture is subsequently stirred at 160° C. for 32 hours and at speeds of 150 RPM to 450 RPM. The method according to exemplary embodiment 6 is summarized again in the following schematic reaction scheme:

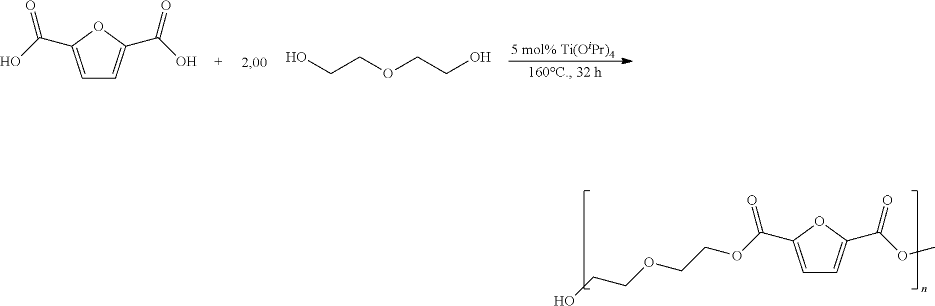

The polyol synthesized by the method is at least partially produced from renewable raw materials. At least the aromatic dicarboxylic acid, which is 2,5-furandicarboxylic acid (FDCA), is predominantly produced, namely to a proportion of at least 98% by weight, from renewable raw materials. In the present case the polyhydric alcohol diethylene glycol is also predominantly produced, namely to a proportion of more than 50% by weight, from renewable raw materials. The polyol has an OH number of greater than 250 mg KOH/g and less than 400 mg KOH/g. The polyol has a content of free glycol of more than 6% by weight and less than 20% by weight with respect to its total mass. The polyol has an average molar mass of less than 1000 g/mol. The polyol has a dynamic viscosity between 3000 mPas and 12 000 mPas. In the present case the polyol has a dynamic viscosity between 4000 mPas and 8000 mPas.

An above-described method for producing rigid PUR/PIR foams makes it possible to produce a rigid PUR/PIR foam having the required properties from the synthesized polyol together with at least one polyisocyanate and at least one blowing agent.

### EXEMPLARY EMBODIMENT 7

In a first method step of a method for synthesizing a polyol for production of rigid PUR/PIR foams according to exemplary embodiment 7, 6.07 mL of diethylene glycol (6.80 g, 64.1 mmol) are initially charged in a 50 mL round-bottom flask fitted with a magnetic stirrer and preheated at 160° C. for 30 minutes. In a second method step of the method 5.00 g of 2,5-furandicarboxylic acid (32.0 mmol, 1.00 eq) as aromatic dicarboxylic acid predominantly produced from renewable raw materials are added. In a departure from the preceding exemplary embodiments, in the second method step of the method according to exemplary embodiment 7, 551 μL/399 mg of dibutyltin(IV) oxide (1.60 mmol) are added as catalyst. With respect to the starting concentration of the 2,5-furandicarboxylic acid, in the present exemplary embodiment the equivalent concentration of the diethylene glycol has a value of 2.00 and the equivalent concentration of the dibutyltin(IV) oxide has a value of 0.05. The resulting reaction mixture is subsequently stirred at 160° C. for 7.5 hours and at speeds of 150 RPM to 450 RPM. The method according to exemplary embodiment 7 is summarized again in the following schematic reaction scheme:

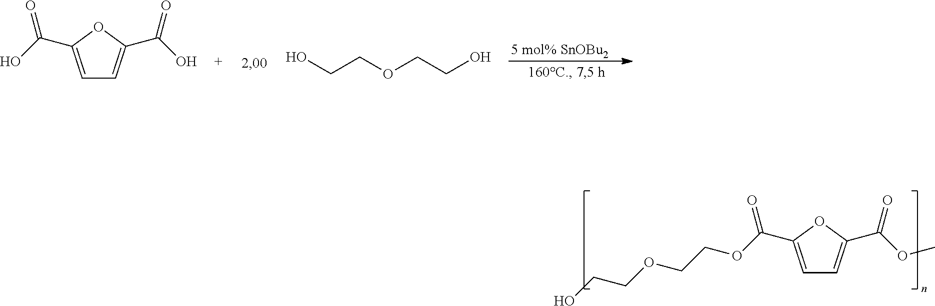

The polyol synthesized by the method is at least partially produced from renewable raw materials. At least the aromatic dicarboxylic acid, which is 2,5-furandicarboxylic acid (FDCA), is predominantly produced, namely to a proportion of at least 98% by weight, from renewable raw materials. In the present case the polyhydric alcohol diethylene glycol is also predominantly produced, namely to a proportion of more than 50% by weight, from renewable raw materials. The polyol has an OH number of greater than 250 mg KOH/g and less than 400 mg KOH/g. The polyol has a content of free glycol of more than 6% by weight and less than 20% by weight with respect to its total mass. The polyol has an average molar mass of less than 1000 g/mol. The polyol has a dynamic viscosity between 3000 mPas and 12 000 mPas. In the present case the polyol has a dynamic viscosity between 4000 mPas and 8000 mPas.

An above-described method for producing rigid PUR/PIR foams makes it possible to produce a rigid PUR/PIR foam having the required properties from the synthesized polyol together with at least one polyisocyanate and at least one blowing agent.

### EXEMPLARY EMBODIMENT 8

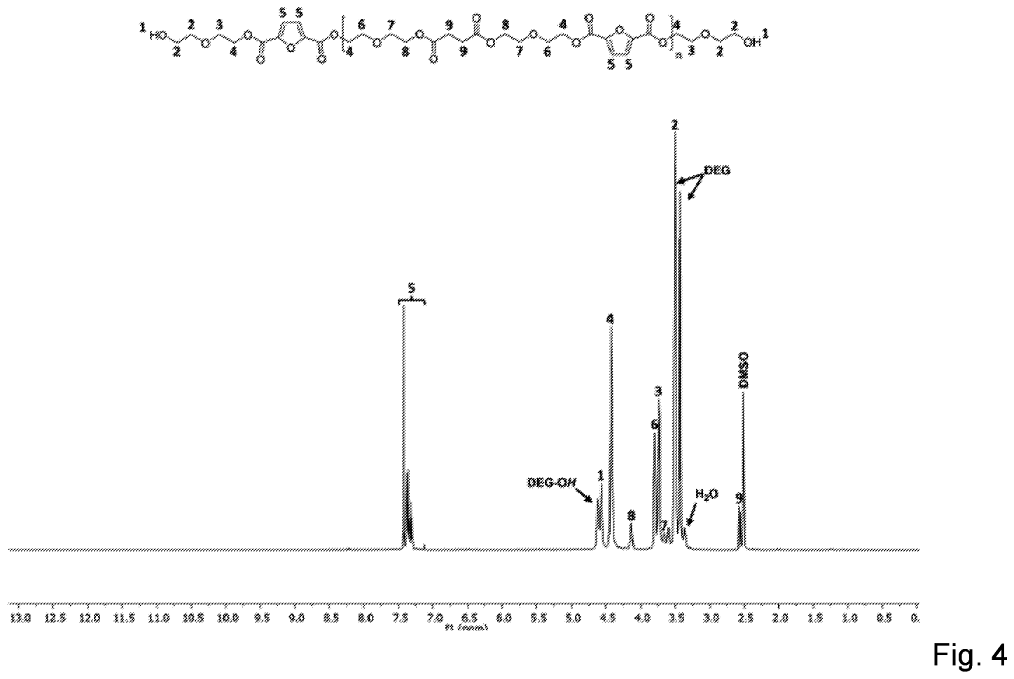

In a first method step of a method for synthesizing a polyol for producing rigid PUR/PIR foams according to exemplary embodiment 8, 121 mL of diethylene glycol (136 g, 1.28 mol, 2.00 eq) are initially charged in a 500 mL three-necked flask fitted with a mechanical stirrer and a distillation bridge and preheated to 160° C. for 30 minutes. Subsequently, in a second method step of the method 9.48 mL of tetraisopropyl orthotitanate (9.10 g, 32.0 mmol, 0.05 eq) as titanium-containing catalyst, 90.0 g of 2,5-furandicarboxylic acid (577 mmol, 0.90 eq) as an aromatic dicarboxylic acid predominantly produced from renewable raw materials and 7.57 g of succinic acid (64.1 mmol, 0.10 eq) which is predominantly produced from renewable raw materials as a further dicarboxylic acid are added and the reaction mixture is stirred while the condensate is continuously removed by distillation. The reaction process is monitored by 1H-NMR, and the reaction is stopped as soon as complete conversion of FDCA is observed. FIG. 4 shows the structural formula and the result of the ¹H-NMR of the polyol according to exemplary embodiment 8 measured in DMSO-d6.

The ¹H-NMR data are as follows:

¹H-NMR (500 MHZ, DMSO-d6): δ/ppm=7.28-7.44 (m, H⁵), 4.61 (s, O(CH₂CH₂OH)₂), 4.56 (s, OCH₂CH₂OH¹), 4.38-4.44 (m, OCH₂CH₂⁴O), 4.09-4.16 (m, OCH₂CH₂⁸O), 3.76-3.81 (m, OCH₂⁶CH₂⁶OCHO), 3.70-3.75 (m, OCH₂³CH₂OCHO), 3.62-3.68 (m, OCH₂⁷CH₂OCHO), 3.45-3.53 (m, OCH₂²CH₂²OH+O(CH₂CH₂OH)₂), 3.38-3.43 (m, O(CH₂CH₂OH)₂).

Carbon-13 (C13) nuclear magnetic resonance was also performed with the following results:

¹³C-NMR (126 MHZ, DMSO-d6): δ/ppm=171.9-172.0, 157.2-157.5, 146.0-146.2, 131.3-131.8, 119.0-119.4, 72.4, 72.3, 68.0-68.2, 64.7-64.8,64.5-64.7, 64.2-64.4, 63.6, 63.4, 62.9, 60.3, 60.2.

Infrared spectroscopy was also performed with the following results:

IR (ATR platinum diamond): v/cm⁻¹=3407, 2874, 1716, 1581, 1509, 1452, 1382, 1271, 1224, 1120, 1062, 1020, 964, 924, 889, 827, 764, 618, 479.

### EXEMPLARY EMBODIMENT 9

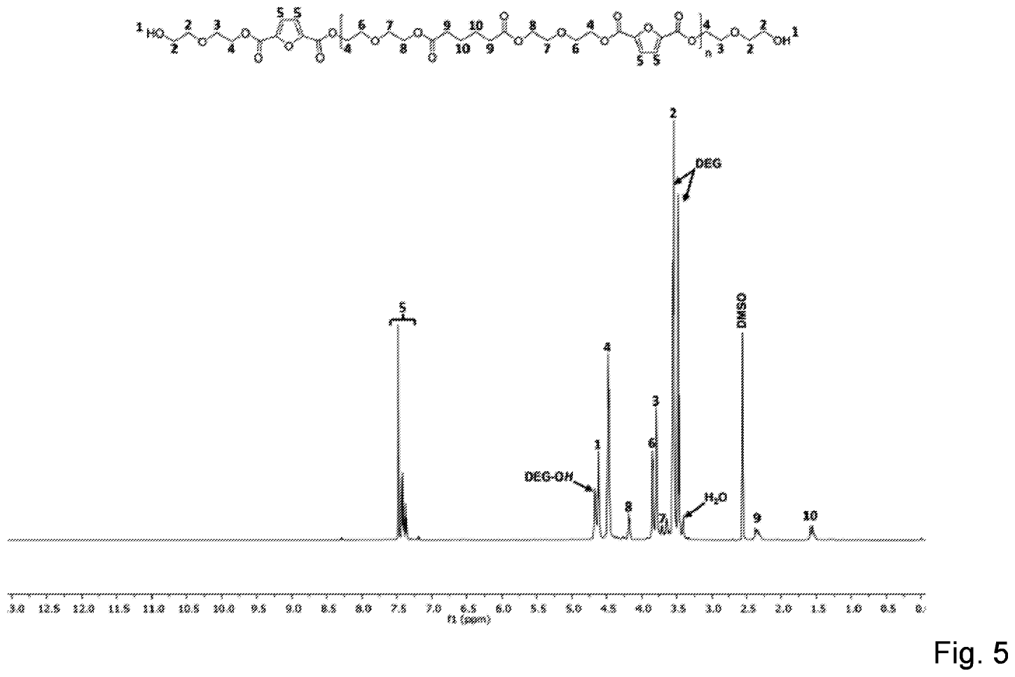

In a first method step of a method for synthesizing a polyol for producing rigid PUR/PIR foams according to exemplary embodiment 9, 121 mL of diethylene glycol (136 g, 1.28 mol) as polyhydric alcohol are initially charged in a 500 mL three-necked flask fitted with a mechanical stirrer and a distillation bridge and preheated to 160° C. for 30 minutes. Subsequently, in a second method step of the method 9.48 mL of tetraisopropyl orthotitanate (9.10 g, 32.0 mmol, 0.05 eq) as titanium-containing catalyst, 90.0 g of 2,5-furandicarboxylic acid (577 mmol, 0.90 eq) as an aromatic dicarboxylic acid which is predominantly produced from renewable raw materials and 9.36 g of adipic acid (64.1 mmol, 0.10 eq) which is predominantly produced from renewable raw materials are added and the reaction mixture stirred while the condensate is continuously removed by distillation. The reaction process is monitored by 1H-NMR, and the reaction is stopped as soon as complete conversion of FDCA is observed. FIG. 5 shows the structural formula and the result of the ¹H-NMR of the polyol according to exemplary embodiment 9 measured in DMSO-d6.

The ¹H-NMR data are as follows:

¹H-NMR (500 MHZ, DMSO-d6): δ/ppm=7.28-7.44 (m, H⁵), 4.61 (s, O(CH₂CH₂OH)₂), 4.56 (t, OCH2CH2OH¹), 4.38-4.44 (m, OCH₂CH₂⁴O), 4.09-4.15 (m, OCH₂CH₂⁸O), 3.76-3.81 (m, OCH₂⁶CH₂OCHO), 3.70-3.75 (m, OCH₂³CH₂OCHO), 3.62-3.68 (m, OCH₂⁷CH₂OCHO), 3.45-3.53 (m, OCH₂²CH₂²OH+O(CH₂CH₂OH)₂), 3.38-3.43 (m, O(CH₂CH₂OH)₂).

Carbon-13 (C13) nuclear magnetic resonance was also performed with the following results:

¹³C-NMR (126 MHz, DMSO-d6): δ/ppm=172.6-172.8, 157.2-157.5, 145.9-146.2, 131.3-131.8, 119.0-119.4, 72.4, 72.3, 67.9-68.3, 64.6-64.7,64.2-64.4, 62.8-63.2, 60.3, 60.2.

Infrared spectroscopy was also performed with the following results:

IR (ATR platinum diamond): v/cm⁻¹=3402, 2873, 1716, 1581, 1509, 1453, 1382, 1271, 1224, 1220, 1061, 1021, 964, 924, 889, 827, 765, 618, 481.

### EXEMPLARY EMBODIMENT 10

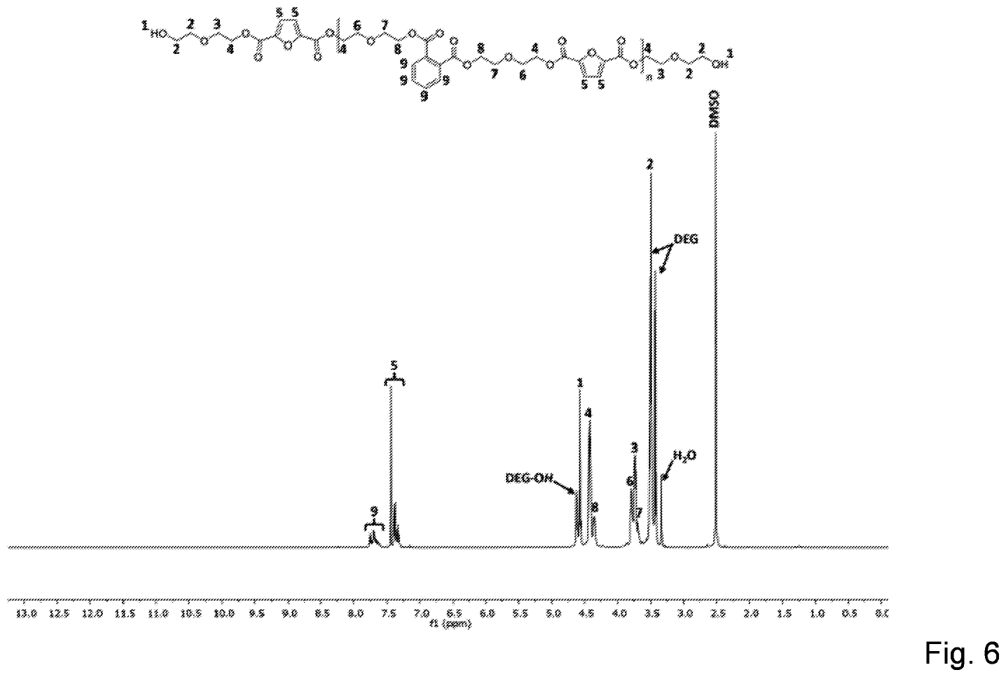

In a first method step of a method for synthesizing a polyol for producing rigid PUR/PIR foams according to exemplary embodiment 10, 121 mL of diethylene glycol (136 g, 1.28 mol, 2.00 eq) are initially charged in a 500 mL three-necked flask fitted with a mechanical stirrer and a distillation bridge and preheated to 160° C. for 30 minutes. Subsequently, in a second method step of the method 9.48 mL of tetraisopropyl orthotitanate (9.10 g, 32.0 mmol, 0.05 eq) as titanium-containing catalyst, 80.0 g of 2,5-furandicarboxylic acid (513 mmol, 0.80 eq) as an aromatic dicarboxylic acid predominantly produced from renewable raw materials and 21.3 g of phthalic acid (128 mmol, 0.20 eq) as a further aromatic dicarboxylic acid are added and the reaction mixture stirred while the condensate is continuously removed by distillation. The reaction process is monitored by 1H-NMR, and the reaction is stopped as soon as complete conversion of FDCA is observed. FIG. 6 shows the structural formula and the result of the ¹H-NMR of the polyol according to exemplary embodiment 10 measured in DMSO-d6.

The ¹H-NMR data are as follows:

¹H-NMR (500 MHZ, DMSO-d6): δ/ppm=7.58-7.78 (m, H⁹), 7.28-7.44 (m, H⁵), 4.61 (s, O(CH₂CH₂OH)₂), 4.56 (s, OCH₂CH₂OH¹), 4.38-4.44 (m, OCH₂CH₂⁴O), 4.30-4.38 (m, OCH₂CH₂⁸O), 3.76-3.81 (m, OCH₂⁶CH₂OCHO), 3.70-3.75 (m, OCH₂³CH₂OCHO), 3.65-3.70 (m, OCH₂⁷CH₂OCHO), 3.45-3.53 (m, OCH₂²CH₂²OH+O(CH₂CH₂OH)₂), 3.38-3.43 (m, O(CH₂CH₂OH)₂).

Carbon-13 (C13) nuclear magnetic resonance was also performed with the following results:

¹³C-NMR (126 MHZ, DMSO-d6): δ/ppm=166.8-167.0, 157.2-157.5, 146.0-146.2, 131.3-131.8, 128.6-128.8, 119.0-119.4, 72.4, 72.3, 68.0-68.2, 64.7-64.8,64.5-64.7, 64.3-64.4, 64.2-64.3, 60.3, 60.2.

Infrared spectroscopy was also performed with the following results:

IR (ATR platinum diamond): v/cm⁻¹=3402, 2874, 1716, 1581, 1509, 1451, 1381, 1271, 1224, 1119, 1065, 1021, 964, 924, 889, 827, 765, 705, 618, 480.

1. A rigid PUR/PIR foam produced from at least one polyol which is synthesized from at least one polyhydric alcohol and at least one aromatic dicarboxylic acid, wherein at least 50% by weight of the polyol is produced from renewable raw materials and at least the aromatic dicarboxylic acid is produced to a predominant proportion of more than 50% by weight from renewable raw materials, the aromatic dicarboxylic acid being 2,5-furandicarboxylic acid (FDCA), which is predominantly produced from renewable raw materials.

2. (canceled)

3. (canceled)

4. The rigid PUR/PIR foam as claimed in claim 1, wherein at least the polyhydric alcohol is predominantly produced from renewable raw materials.

5. The rigid PUR/PIR foam as claimed in claim 1, wherein the polyol has an OH number greater than 250 mg KOH/g.

6. The rigid PUR/PIR foam as claimed in claim 1, wherein the polyol has a content of free glycol of greater than 6% by weight with respect to the total mass of the polyol.

7. The rigid PUR/PIR foam as claimed in claim 1, wherein the polyol has an average molar mass of less than 1,000 g/mol.

8. The rigid PUR/PIR foam as claimed in claim 1, wherein the polyol is synthesized at least partially from at least one further dicarboxylic acid.

9. The rigid PUR/PIR foam as claimed in claim 8, wherein the further dicarboxylic acid is an aliphatic dicarboxylic acid which is predominantly produced from renewable raw materials.

10. The rigid PUR/PIR foam as claimed in claim 1, wherein the polyol has a dynamic viscosity between 3,000 mPas and 12,000 mPas, measured according to the standard DIN EN ISO 3219-1:2021.

11. The rigid PUR/PIR foam as claimed in claim 1, further comprising a thermal conductivity between 0.018 W/(mK) and 0.021 W/(mK), measured by the standard DIN EN 12667.

12. A method for synthesizing a polyol, for producing rigid PUR/PIR foams as claimed in claim 1, from at least one polyhydric alcohol and at least one aromatic dicarboxylic acid, wherein at least 50% by weight of the polyol is produced from renewable materials, and wherein at least one aromatic dicarboxylic acid is employed, which is produced to a predominant proportion of more than 50% by weight from renewable materials, wherein 2,5-furandicarboxylic acid (FDCA), which is predominantly produced from renewable materials, is employed as an aromatic dicarboxylic acid.

13. (canceled)

14. (canceled)

15. The method as claimed in claim 12, wherein diethylene glycol (DEG) is employed as the polyhydric alcohol, and the method is carried out according to the following generalized reaction scheme: 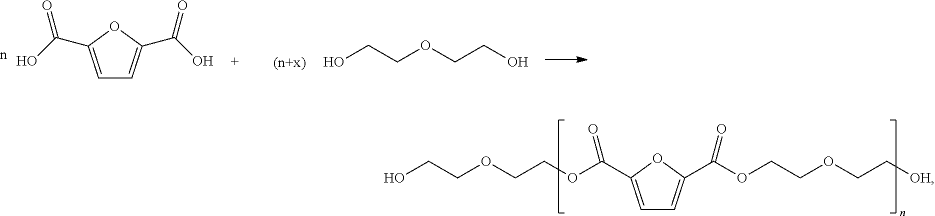
wherein n may in particular assume positive values between 1.0 and 10.0 and x may in particular assume positive values between 0.0 and 5.0.

16. The method as claimed in claim 12, wherein at least one polyhydric alcohol is employed, which is predominantly produced from renewable raw materials.

17. The method as claimed in claim 12, wherein at least one catalyst is employed.

18. The method as claimed in claim 17, wherein a titanium-containing catalyst is employed as a catalyst.

19. The method as claimed in claim 12, wherein the polyhydric alcohol is employed in an equivalent concentration between 1.75 and 2.00 with respect to a starting concentration of dicarboxylic acid(s).

20. The method as claimed in claim 12, wherein a reaction mixture composed of the starting materials is stirred at a temperature between 60° C. and 240° C.

21. The method as claimed in claim 12, wherein additionally at least one further dicarboxylic acid is employed.

22. The method as claimed in claim 12, wherein additionally at least one surfactant is employed, which is predominantly produced from renewable raw materials.

23. A polyol synthesized by a method as claimed in claim 12.

24. The polyol as claimed in claim 23, wherein the polyol is poly(diethylene glycol furanoate) (PDEF), which has the following generalized structure: 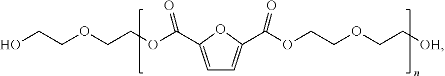
wherein n may especially assume positive values between 1.0 and 10.0.

25. A method for producing rigid PUR/PIR foams, as claimed in claim 1, wherein at least one polyisocyanate, at least one polyol synthesized, and at least one blowing agent are converted into a rigid PUR/PIR foam.
